(19) United States
(12) Patent Application Publication
(10) Pub. No.: US 2018/0060897 A1
(43) Pub. Date: Mar. 1, 2018

(54) RULE-BASED DATA PROCESSING ENGINE

(71) Applicant: NCR Corporation, Duluth, GA (US)

(72) Inventors: Sean Paul Loosli, Mountain View, CA (US); Suresh R. Rao, Santa Clara, CA (US); Suzan Szollar, Menlo Park, CA (US)

(21) Appl. No.: 15/254,286

(22) Filed: Sep. 1, 2016

(51) Int. Cl. G06Q 30/02

(52) U.S. Cl. CPC G06Q 30/0225; G06Q 30/0233

(57) ABSTRACT

Various embodiments herein relate to data processing, in particular with regard to a rule-based data processing engine. Such a rule-based data processing engine is employed in various embodiments to apply rules to customer data to generate offers of systems and programs, such as credit card and customer loyalty offerings, that achieve desired goals of an offering entity. One embodiment includes identifying at least one program for which an individual qualifies based upon data of the individual in view of respective program qualification criteria. This method further includes determining, for each identified program, at least one variable parameter of the respective program based on a respective parameter rule. This method then transmits, via a network, representations of each of the identified programs with respective determined parameters for presentation within a user interface.

### BACKGROUND INFORMATION

Systems and programs are typically offered with a limited number of options, such as credit accounts offered by a bank may come in a limited number of options. This may include options for bad, average, and excellent credit ratings. Each of these offerings typically has inflexible parameters, although some parameters may be altered by an offering entity without consultation with the customer. This inflexibility prevents entities from offering terms and parameters tailored for specific purposes.

At the same time, system and program customers, such as credit card customers, cannot easily compare offerings as the offers are often presented through different forms of media, on different documents, and from different entities. These limitations can confound customers when comparing multiple offerings.

### SUMMARY

Various embodiments herein relate to data processing, in particular with regard to a rule-based data processing engine. Such a rule-based data processing engine is employed in various embodiments to apply rules to customer data to generate offers of systems and programs, such as credit card and customer loyalty offerings, that achieve desired goals of an offering entity. Such goals may be sustained or increased customer loyalty, increasing profit or market share, and the like. Further, customers are able to provide their information once in some such embodiments and receive a plurality of offers presented consistently with one another.

One such embodiment in the form of a method includes identifying, from a plurality of programs, at least one program for which an individual qualifies based upon data of the individual in view of respective program qualification criteria. This method further includes determining, for each identified program, at least one variable parameter of the respective program based on a respective parameter rule, such as a number of points or miles that may be earned when using a credit card or an interest rate. This method then transmits, via a network, representations of each of the identified programs with respective determined parameters for presentation within a user interface.

Another method embodiment includes storing a plurality of credit account program data structures for credit account program types. Each data structure in such embodiments includes at least one qualification rule, each qualification rule identifying minimum or maximum values or ratios of one or a combination of financial-related data items. Each data structure also includes at least one variable parameter rule determining a variable value of at least one of an interest rate, a reward-granting parameter, a reward amount, and a reward denomination. The method of such embodiments executes a rules engine against data of an individual to apply qualification rules of the credit account program data structures to identify any credit account program types the individual qualifies for. The method also executes the rules engine against variable parameter rules for each credit account program type for which the individual qualifies to determine the variable parameters. The method may then output the credit account program types with respective determined variable parameters as credit account offers for the individual.

Another embodiment is in the form of a system. The system of such embodiments includes at least one network interface device, at least one processor, and at least one memory device. The at least one memory device stores instructions executable by the processor to perform data processing activities. The data processing activities include executing a rules engine against data of an individual to apply qualification rules of credit account program data structures to identify any credit account program types the individual qualifies for. The data processing activities further include executing the rules engine against variable parameter rules associated with each credit account program type for which the individual qualifies to determine variable parameters. The data processing activities also include outputting, via the at least one networking interface device, the credit account program types with respective determined variable parameters as credit account offers for the individual.

### BRIEF DESCRIPTION OF THE DRAWINGS

FIG. 1 is a logical block diagram of a system, according to an example embodiment.

FIG. 2 is a block diagram of a computing device, according to an example embodiment.

FIG. 3 is a block flow diagram of a method, according to an example embodiment.

FIG. 4 is a block flow diagram of a method, according to an example embodiment.

### DETAILED DESCRIPTION

Various embodiments herein relate to data processing, in particular with regard to a rule-based data processing engine. Such a rule-based data processing engine is employed in various embodiments to apply rules to customer data to generate offers of systems and programs, such as credit card and customer loyalty offerings, that achieve desired goals of an offering entity. Such goals may be sustained or increased customer loyalty, increasing profit or market share, and the like. Further, customers are able to provide their information once in some such embodiments and receive a plurality of offers presented consistently with one another.

Such embodiments may be employed to provide a competitive marketplace for consumers to find the best reward options along with selecting the products that best match their financial needs. Such embodiments also enable financial institutions providing credit programs and reward granting programs to receive qualified leads and customers and also providing a mechanism through which customers having desired properties can be given greater rewards, lower interest rates, other benefits, or a combination thereof to achieve goals of the offering financial institution.

Some embodiments provide an open marketplace where a consumer can see multiple offers for the best reward options, given their individual financial situation. However, rather than merely seeing a listing of standard offers for which the consumer would pre-qualify, the granting institution(s) are able to customize offers to ‘compete’ for the customers that best meet their respective targets. Some embodiments include an auction component wherein the granting or partner institutions are able to ‘bid up’ their offers to entice customers toward their financial products, such as upon receipt of an offer rejection or in comparison to other offers by the implementing system before providing offers to the customer.

In one embodiment, financial institutions partner with merchants, airlines, hospitality companies, and other companies to deliver compelling rewards for using their purchasing card products as is already well known. However, rather than having a user apply for a specific card with a specific reward, the user submits their financial details and in return is presented with a series of offers from either their financial institution of choice or from partner institutions when the embodiment is implemented as a clearinghouse for multiple financial institutions. In some such clearinghouse embodiments, for a fixed period of time, these partners have the opportunity to enhance the offer presented in order to entice the customer.

For instance, a department store could offer a $100 reward for spending $1,000 in their stores, while an airline offers $300 after spending $4,000 in the first 3 months. However, the department store may decide to counter with a more compelling reward, raising to $200 reward for spending $1,500 in-store, based on the consumer's information and desirability. The offer adjustment, both the decision to do so and the change made is employed through application of one or more rules against data of the of customer and data of other offers. The consumer then receives the best possible offer for their situation, the financial institution is able to keep or gain more business and deliver additional products to their end users by enticing them to stay within or join their network of card providers, and the retailers can draw additional or retain business at an acceptable risk/reward profile.

In other embodiments, financial institutions can use the end user's financial information to provide them with better offers even before they apply. This dynamic cross-sell could be more enticing than seeing the stock rewards that are continuously offered, and merchant partners could continue to dynamically raise and lower the reward for particularly desirable customers in an attempt to capture their business at the lowest acceptable reward threshold, thereby achieving defined business goals at a lower cost. For example, a financial institution partner may offer a department store card with a $50 reward for $1.000 of in-store purchases, for purchase of a particular product, based on a number of store visits or purchase transactions, and the like. After the user does not claim the offer for a certain period of time, the department store can raise the reward threshold in an attempt to make the offer more compelling. These reward thresholds and time periods may be pre-set by the partners, or may be algorithmically and dynamically calculated. Simultaneously, other partners could compete for the same consumer by offering other compelling rewards after a user has not claimed a given reward after a period of time.

This platform in some embodiments, as briefly mentioned above, is implemented as a third-party platform with multiple financial institutions and partners competing for the same consumer. In such embodiments, a consumer submit their application data, and the participating financial institutions and partners are able to compete in an auction-style to entice the consumer. If the consumer does not claim any of the offers, the financial institutions may be provided with an opportunity to increase the reward threshold or elect to persist or withdraw the original offer. Here the same dynamics as above apply, with many financial institutions competing against each other for the consumer debt, rather than the vendor partners competing for business within a given financial institution.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural logical and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor. ASIC, microprocessor, or other type of processor operating on a system such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

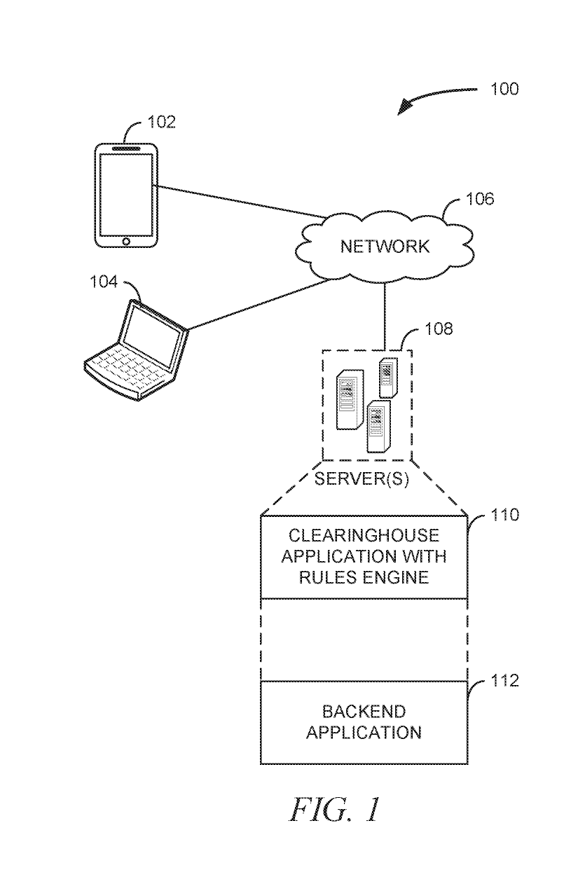

FIG. 1 is a logical block diagram of a system 100, according to an example embodiment. The system 100 is an example of a system on which some embodiments are implemented. The system 100 includes customer computing devices, such as a mobile device 102 or personal computer 104, that connect to a network 106, such as the Internet, to request, receive, and consider program offerings provided by software executing on one or more servers 108.

The customer computing devices, e.g., the mobile device 102 and personal computer 104, are used in some embodiments to request program offers. Such programs may be credit cards, loans, insurance policies, and other products and service offerings that include variables and possibly accompanying reward programs. The customer computing devices may include a web browser or dedicated app or application that is used in such embodiments to request program offers.

The server(s) 108 may be physical or virtual servers that executing software to service program offer requests, such as by a clearinghouse application with a rules engine 110. The software may also include one or more backend applications 112 that may be executed to open new accounts, to communicate with financial institutions and other entities on whose behalf the clearinghouse application 110 operates, and the like. The clearinghouse application 110 and the backend application 112 may execute on the same server 108 or different severs 108 that may be deployed centrally or disparately across the network 106.

In one embodiment, a customer using one of the customer devices, such as the personal computer 104, may request program offers. The request for program offers may be from a single financial institution the customer already has an account with or from a clearing house that provides such services to a plurality of financial institutions that may provide competing offers for the customer's business through application of rules by the rules engine of the clearing house application 110. In embodiments where program offers are requested from a single financial institution, the customer may access the financial institution to make the request through an online banking website, other website of the financial institution, a mobile banking application of the financial institution, or otherwise. When access a clearinghouse application 110, the customer may access a clearinghouse application 110 website or use an app or application. Some embodiments may also include interactive voice response (IVR) systems that are used to allow customers to request program offers. Additional embodiments may be implemented in self-service terminals (SSTs), such as automated teller machines (ATMs), computerized self-service kiosks such as may be deployed at bank branches and at airline check-ins, and the like.

In operation, the customer requests program offers from their device of choice, such as the personal computer 104. The request is submitted to the clearinghouse application 110 on the sever(s) 108 over the network 106. The request may include customer information, such as information used in making credit granting decisions (e.g., name, date of birth, social security number, income, assets, bank account balances, and authorization to check credit report and other data available from third-parties). However, the customer information may include authorization for a financial institution to utilized information already in their possession due to already existing accounts with the financial institution.

The clearinghouse application 110, upon receipt of the customer request, gathers any additional information needed to process the request, such as from local databases and third-party databases, such as credit bureau data. The clearinghouse application 110 then utilizes the rules engine to apply rules of programs against the customer data, first to determine whether the customer qualifies for the program and second, when the customer is qualified, to determine variable parameters for the program, such as interest rates, reward granting rates, bonus rewards for a certain amount of spending or other usage within a defined period, interest rate deductions for certain amounts of spending or other usage or a number of on-time payments, and the like.

The offers for which the customer qualifies and parameters have been set by the rules engine may then be returned to the customer computing device. However, in some embodiments, further rules may be applied by the rules engine for comparing offers against one another. For instance, one credit card program may include a rule that when a customer's credit score is in the certain range, the customer is to be offered up to two-percent cash back, but only if offers from other programs offer one-percent or greater cash back. Similar rules may also be included in rules with regard to other rewards, such as points or miles, interest rate reductions, and the like. Once the offers have been compared and altered by the rules engine in such embodiments, the offers are returned to customer computing device. In some embodiments, data of offers provided to the customer are stored in a database.

The offers are then presented on the customer computing device and the customer may accept, reject, or ignore offers. Note that in a some embodiments, a customer is allowed to accept only one offer as acceptance of an offer may change the credit granting data upon which an offer is based. Also, some offers may time out if not accepted and be treated as rejected. When an offer is rejected, the rejection is sent back over the network 106 to the clearinghouse application 110. The rejection may be updated to the database in embodiments where data of the rejected offer was stored to the database and may be the subject of further processing to make another offer. For example, the offer may be processed by rules in the rules engine to increase reward value, such as an initial offer that provided 10.000 points for $1,000 of spending in six months and a revised offer that provides 20,000 points of $500 of spending within a year. The revised offer may then be again provided to the customer.

In some embodiments, when a customer accepts an offer, all other pending offers are automatically rejected or otherwise closed and acceptance processing begins. The acceptance processing may include updating stored offer data with regard to the accepted offer and the non-accepted, therefore rejected, offers. The acceptance processing may further include transmitting customer data to the backend application 112, which may be a banking system backend application of a financial institution that operated the program of the accepted offer. The acceptance processing then continues from there and operated to provide the service or product of the accepted offer to the customer.

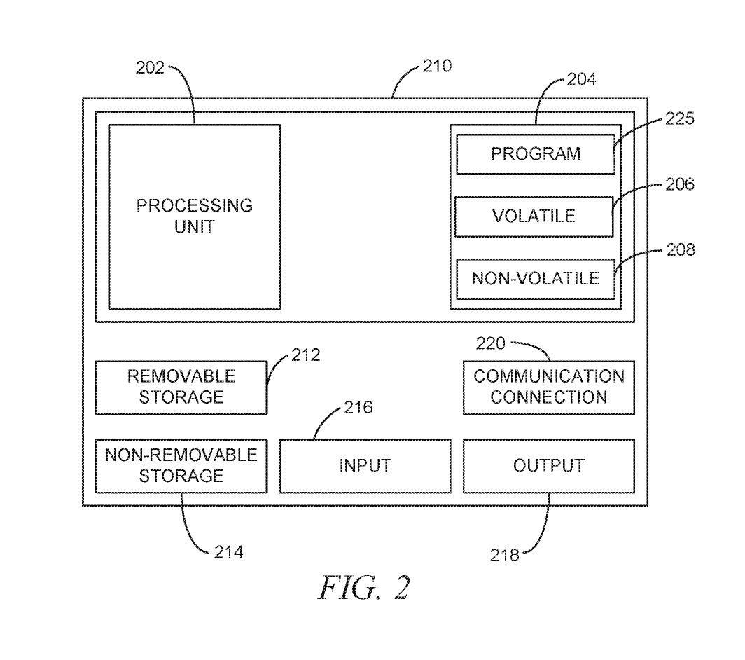

FIG. 2 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 210, may include a processing unit 202, memory 204, removable storage 212, and non-removable storage 214. Although the example computing device is illustrated and described as computer 210, the computing device may be in different forms in different embodiments. For example, the computing device may instead be a smartphone, a tablet, smartwatch, or other computing device including the same or similar elements as illustrated and described with regard to FIG. 2. Devices such as smartphones, tablets, and smartwatches are generally collectively referred to as mobile devices. Further, although the various data storage elements are illustrated as part of the computer 210, the storage may also or alternatively include cloud-based storage accessible via a network, such as the Internet.

Returning to the computer 210, memory 204 may include volatile memory 206 and non-volatile memory 208. Computer 210 may include—or have access to a computing environment that includes a variety of computer-readable media, such as volatile memory 206 and non-volatile memory 208, removable storage 212 and non-removable storage 214. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM). Digital Versatile Disks (DVD) or other optical disk storage, magnetic cassettes, magnetic tape, magnetic disk storage or other magnetic storage devices, or any other medium capable of storing computer-readable instructions.

Computer 210 may include or have access to a computing environment that includes input 216, output 218, and a communication connection 220. The input 216 may include one or more of a touchscreen, touchpad, mouse, keyboard, camera, one or more device-specific buttons, one or more sensors integrated within or coupled via wired or wireless data connections to the computer 210, and other input devices. The computer 210 may operate in a networked environment using a communication connection 220 to connect to one or more remote computers, such as database servers, web servers, and other computing device. An example remote computer may include a personal computer (PC), server, router, network PC, a peer device or other common network node, or the like. The communication connection 220 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 220 may also or alternatively include a transceiver device, such as a BLUETOOTH® device that enables the computer 210 to wirelessly receive data from and transmit data to other BLUETOOTH® devices.

Computer-readable instructions stored on a computer-readable medium are executable by the processing unit 202 of the computer 210. A hard drive (magnetic disk or solid state), CD-ROM, and RAM are some examples of articles including a non-transitory computer-readable medium. For example, various computer programs 225 or apps, such as one or more applications and modules implementing one or more of the methods illustrated and described herein or an app or application that executes on a mobile device or is accessible via a web browser, may be stored on a non-transitory computer-readable medium.

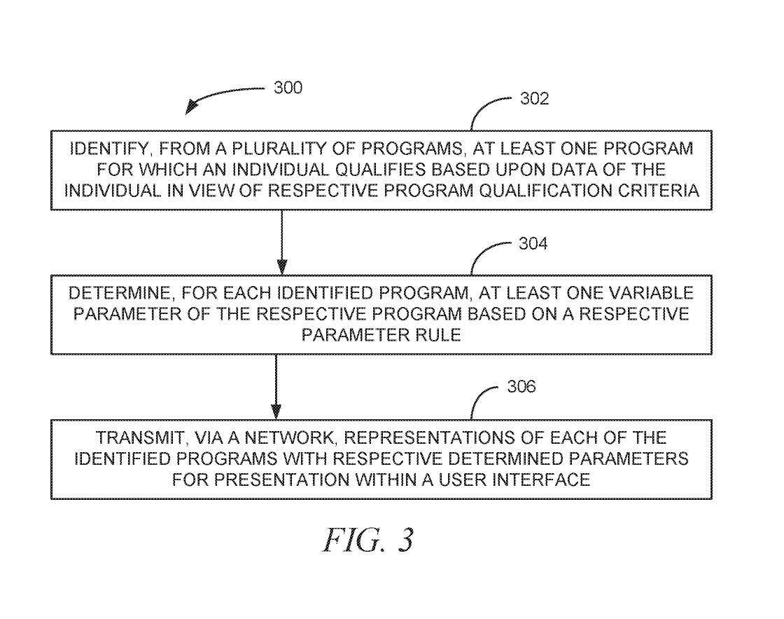

FIG. 3 is a block flow diagram of a method 300, according to an example embodiment. The method 300 is an example of a method that may be performed to provide program offers to a requesting customer. In some embodiments, the method 300 may be performed by the clearinghouse application of FIG. 1.

The method 300 includes identifying 302, from a plurality of programs, at least one program for which an individual qualifies based upon data of the individual in view of respective program qualification criteria. The method 300 may then determine 304, for each identified 302 program, at least one variable parameter of the respective program based on a respective parameter rule and subsequently transmit 306, via a network, representations of each of the identified 302 programs with respective determined 304 parameters for presentation within a user interface.

In some embodiments of the method 300, at least a portion of the data of the individual is received as input via the network. In some such embodiments and others at least a portion of the data of the individual is stored in and retrieved from a database for an authenticated user, which may include data retrieved from a third-party data provider, such as a credit bureau.

In some method 300 embodiments, the representations of each of the identified 302 programs with respective determined 304 parameters for presentation within a user interface includes data to be presented within a mobile device app. In other embodiments, the transmitted 306 representations are included in a web page transmitted for presentation within a web browser.

In a further embodiment, a program type is stored as a data structure with rules. The rules in some such embodiments include qualification criteria in the form of at least one qualification rule. The data structure may also include program parameters at least one of which is variable and a variable parameter rule for each of the variable parameters. In some such embodiments, the plurality of programs are credit account types and a qualification rule includes financial-related data rules identifying minimum or maximum values or ratios of one or a combination of financial-related data items. Further, a variable parameter may include an interest rate, a reward-granting parameter, a reward amount, a reward denomination, and other such parameters. The method 300 in some such embodiments may further include storing representations of each of the identified programs with respective determined parameters and receiving a rejection of at least one of the identified programs. In such embodiments, the method 300 may then re-determine variable parameters for each rejected identified program in view of the stored representation of the rejected identified program and stored variable parameters thereof and then transmit, via the network, representations of each of the identified programs for which variable parameters have been re-determined.

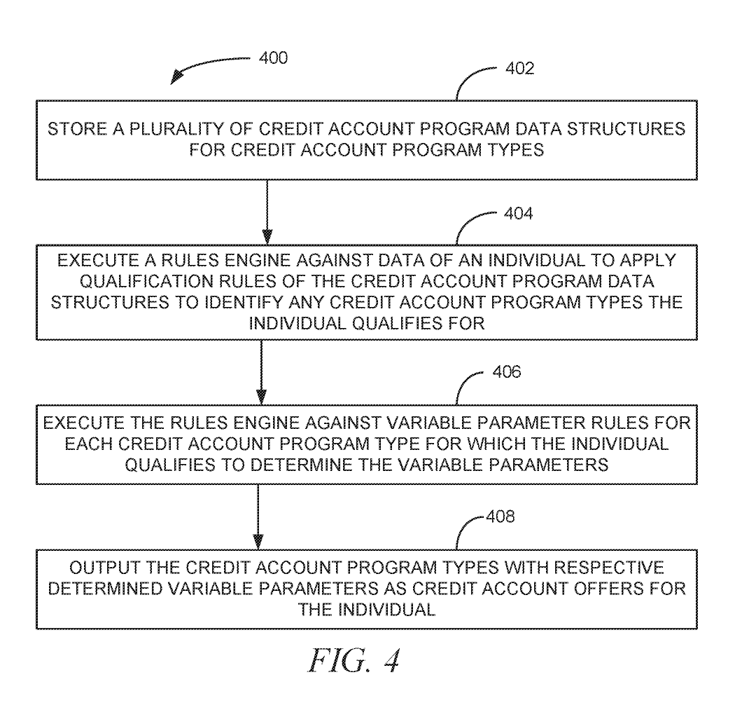

FIG. 4 is a block flow diagram of a method 400, according to an example embodiment. The method 400 is an example of a method that may be performed to provide program offers to a requesting customer. In some embodiments, the method 400 may be performed by the clearinghouse application of FIG. 1.

The method 400 includes storing 402 a plurality of credit account program data structures for credit account program types. In some embodiments, each stored 402 data structure includes at least one qualification rule and at least one variable parameter rule. Each qualification rule typically identifies minimum or maximum values or ratios of one or a combination of financial-related data items. Each variable parameter rule may be applied to determine a variable value, such as an interest rate, a reward-granting parameter, a reward amount, and a reward denomination.

The method 400 further includes executing 404 a rules engine against data of an individual to apply qualification rules of the credit account program data structures to identify any credit account program types the individual qualifies for. The method 400 then executes 406 the rules engine against variable parameter rules for each credit account program type for which the individual qualifies to determine the variable parameters. The method 400 may then output 408 the credit account program types with respective determined variable parameters as credit account offers for the individual. The outputting 408 may include transmitting data via a network for presentation in a mobile device app, within a web browser, on an ATM or other SST, and the like.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
identifying, from a plurality of programs, at least one program for which an individual qualifies based upon data of the individual in view of respective program qualification criteria;
determining, for each identified program, at least one variable parameter of the respective program based on a respective parameter rule; and
outputting representations of each of the identified programs with respective determined parameters for presentation within a user interface.

2. The method of claim 1, wherein at least a portion of the data of the individual is received as input.

3. The method of claim 2, wherein at least a portion of the data of the individual is stored in and retrieved from a database for an authenticated user.

4. The method of claim 3, wherein at least a portion of the data is retrieved from a third-party data provider.

5. The method of claim 1, wherein the representations of each of the identified programs with respective determined parameters for presentation within a user interface includes data to be presented within a mobile device app.

6. The method of claim 1, wherein the transmitted representations are included in a web page transmitted for presentation within a web browser.

7. The method of claim 1, wherein a program type is stored as a data structure with rules, the rules including qualification criteria in the form of at least one qualification rule, program parameters at least one of which is variable, and a variable parameter rule for each of the variable parameters.

8. The method of claim 7, wherein:
the plurality of programs are credit account types;
a qualification rule includes financial-related data rules identifying minimum or maximum values or ratios of one or a combination of financial-related data items; and
a variable parameter includes at least one of an interest rate, a reward-granting parameter, a reward amount, and a reward denomination.

9. The method of claim 8, further comprising:
storing representations of each of the identified programs with respective determined parameters;
receiving a rejection of at least one of the identified programs;
re-determining variable parameters for each rejected identified program in view of the stored representation of the rejected identified program and stored variable parameters thereof; and
outputting representations of each of the identified programs for which variable parameters have been re-determined.

10. A method comprising:
storing a plurality of credit account program data structures for credit account program types, each data structure including:
at least one qualification rule, each qualification rule identifying minimum or maximum values or ratios of one or a combination of financial-related data items; and
at least one variable parameter rule determining a variable value of at least one of an interest rate, a reward-granting parameter, a reward amount, and a reward denomination;
executing a rules engine against data of an individual to apply qualification rules of the credit account program data structures to identify any credit account program types the individual qualifies for;
executing the rules engine against variable parameter rules for each credit account program type for which the individual qualifies to determine the variable parameters; and
outputting the credit account program types with respective determined variable parameters as credit account offers for the individual.

11. The method of claim 10, wherein the outputting includes transmitting data via a network for presentation in a mobile device app.

12. The method of claim 10, wherein the data of the individual is retrieved from a database storing account holder data.

13. The method of claim 10, further comprising:
storing representations of each of the identified programs with respective determined variable parameters;
receiving a rejection of at least one of the identified programs;
re-determining variable parameters for each rejected identified program in view of the stored representation of the rejected identified program and stored variable parameters thereof; and
outputting the credit account program types with respective re-determined variable parameters as credit account offers for the individual.

14. The method of claim 10, wherein:
at least one qualification rule includes data to be obtained from a third-party data source; and
executing the rules engine includes obtaining the data from the third-party data source.

15. A system comprising:
at least one network interface device;
at least one processor;
at least one memory device storing instructions executable by the processor to perform data processing activities comprising:
executing a rules engine against data of an individual to apply qualification rules of credit account program data structures to identify any credit account program types the individual qualifies for;
executing the rules engine against variable parameter rules associated with each credit account program type for which the individual qualifies to determine variable parameters; and
outputting, via the at least one networking interface device, the credit account program types with respective determined variable parameters as credit account offers for the individual.

16. The system of claim 15, wherein data of the individual is received as input via the at least one network interface device with a request for program offers.

17. The system of claim 15, the data processing activities further comprising:
storing a plurality of credit account program data structures for credit account program types, each data structure including:
at least one qualification rule, each qualification rule identifying minimum or maximum values or ratios of one or a combination of financial-related data items; and
at least one variable parameter rule determining a variable value of at least one of an interest rate, a reward-granting parameter, a reward amount, and a reward denomination.

18. The system of claim 15, the data processing activities further comprising:
storing representations of each of the identified programs with respective determined variable parameters;
receiving a rejection of at least one of the identified programs;
re-determining variable parameters for each rejected identified program in view of the stored representation of the rejected identified program and stored variable parameters thereof; and
outputting the credit account program types with respective re-determined variable parameters as credit account offers for the individual.
